(19) United States
(12) Patent Application Publication
(10) Pub. No.: US 2023/0342176 A1
(43) Pub. Date: Oct. 26, 2023

(54) SYSTEM AND METHOD FOR MANAGING ON-PREM HYPERCONVERGED SYSTEMS USING DARK CAPACITY HOST COMPUTERS

(71) Applicant: VMware, Inc., Palo Alto, CA (US)

(72) Inventors: Vikram Nair, Mountain View, CA (US); Pawan Saxena, Pleasanton, CA (US); Ravi Cherukupalli, San Ramon, CA (US); Larry Henderson, Mountain View, CA (US)

(21) Appl. No.: 17/728,172

(22) Filed: Apr. 25, 2022

(51) Int. Cl. G06F 9/455

(52) U.S. Cl. CPC G06F 9/45558; G06F 9/45545; G06F 2009/4557; G06F 2009/45583; G06F 2009/45595

(57) ABSTRACT

System and computer-implemented method for managing on-prem hyperconverged systems automatically detects a condition for additional resources in an on-prem hyperconverged system with a cluster of active host computers and at least one dark capacity host computer that is not part of the cluster. The resources of at least one dark capacity host computer in the on-prem hyperconverged system is used to address the condition for additional resources after the dark capacity host computer has been added to the cluster.

### BACKGROUND

Current hybrid cloud technologies allow software-defined data centers (SDDCs) to be deployed in a public cloud. These hybrid cloud technologies allow entities, such as enterprises, to modernize, protect and scale their applications leveraging the public cloud without having to manage the infrastructure. However, some entities do not want to move their SDDCs to the public cloud, either because the data cannot leave their premises, or the compute power needs to be close to the applications at their edge locations.

As a result, managed on-prem solutions, such as VMC on AWS Outposts, have been developed to deliver SDDC infrastructure as a service to on-premises locations. Since the SDDC infrastructure is delivered as a service, various infrastructure management operations, such as managing the hardware and software in the infrastructure, troubleshooting issues, and performing patching and maintenance, are executed by the service provider.

However, there are challenges to the managed on-prem solutions. One of these challenges is failure handling for the managed on-prem infrastructure. A managed on-prem solution does not offer the same bare metal availability as the public cloud. Thus, in the event of a failure, the time it would take for new capacity to be purchased and delivered can be significant, which could lead to degraded performance and reduced availability. Another challenges is dynamic scaling in the managed on-prem infrastructure. The managed on-prem infrastructure is delivered as a physical rack with hardware and software needed to support one or more SDDCs. The capacity of scaling a compute cluster on an on-prem rack is not currently supported since there is no additional capacity. Thus, workloads running on the on-prem rack could be affected with respect to performance and may eventually exhaust the resources on the rack.

### SUMMARY

System and computer-implemented method for managing on-prem hyperconverged systems automatically detects a condition for additional resources in an on-prem hyperconverged system with a cluster of active host computers and at least one dark capacity host computer that is not part of the cluster. The resources of at least one dark capacity host computer in the on-prem hyperconverged system is used to address the condition for additional resources after the dark capacity host computer has been added to the cluster.

A computer-implemented method for managing on-prem hyperconverged systems comprises automatically detecting a condition for additional resources in an on-prem hyperconverged system with a cluster of active host computers and at least one dark capacity host computer that is not part of the cluster, wherein the active and dark capacity host computers are physical computers; in response to a detection of the condition for additional resources in the on-prem hyperconverged system, adding the at least one dark capacity host computer to the cluster; and after the at least one dark capacity host computer has been added to the cluster, using resources of the at least one dark capacity host computer to address the condition for additional resources. In some embodiments, the steps of this method are performed when program instructions contained in a computer-readable storage medium are executed by one or more processors.

A system in accordance with an embodiment of the invention comprises memory and at least one processor configured to automatically detect a condition for additional resources in an on-prem hyperconverged system with a cluster of active host computers and at least one dark capacity host computer that is not part of the cluster, wherein the active and dark capacity host computers are physical computers; in response to a detection of the condition for additional resources in the on-prem hyperconverged system, add the at least one dark capacity host computer to the cluster; and after the at least one dark capacity host computer has been added to the cluster, use resources of the at least one dark capacity host computer to address the condition for additional resources.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a distributed system with on-prem hyperconverged systems in accordance with an embodiment of the invention.

FIG. 2 is a diagram of an on-prem hyperconverged system in accordance with an embodiment of the invention.

FIG. 3 is a flow diagram of a process of performing a failover operation in an on-prem hyperconverged system of the distributed system in accordance with an embodiment of the invention.

FIGS. 4A-4G illustrate a process of performing a failover operation in an on-prem hyperconverged system of the distributed system in accordance with an embodiment of the invention.

FIG. 5 is a flow diagram of a process of scaling out the resource capacity of an on-prem hyperconverged system of the distributed system in accordance with an embodiment of the invention.

FIG. 6 is a process flow diagram of a computer-implemented method for managing on-prem hyperconverged systems in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

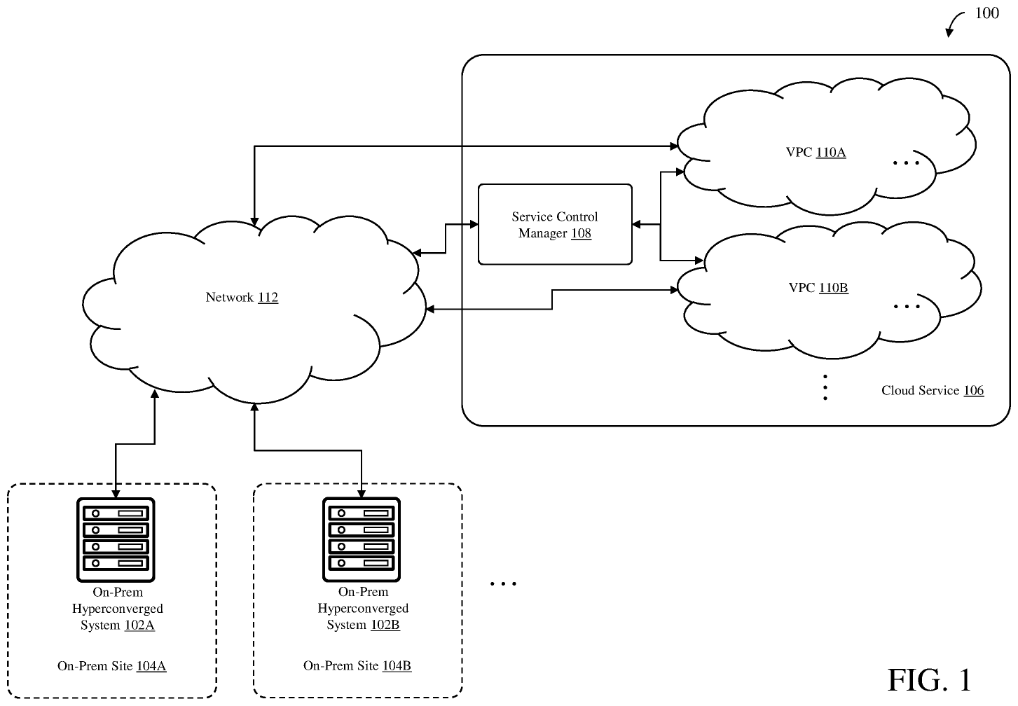

FIG. 1 shows a distributed system 100 with one or more on-premise (on-prem) hyperconverged systems 102 (e.g., 102A, 102B . . . ) in accordance with an embodiment of the invention. Each on-prem hyperconverged system 102 is a complete network infrastructure with the necessary software components already installed and configured to be able to support and operate one or more software-defined data centers (SDDCs) at any on-premises sites 104 (e.g., 104A, 104B . . . ). Thus, each on-prem hyperconverged system includes hardware, such as physical servers, network switches and power supplies, which may be installed in one or more server racks to support the desired number of SDDCs with at least all the necessary virtualization software components already installed to support virtual computing instances, such as virtual machines, to process workloads. In an embodiment, one (1) physical rack may include ten (10) physical servers, and ten (10) physical racks support one (1) SDDC. In FIG. 1, each of the on-premises sites is shown to include one on-prem hyperconverged system. However, the on-premises sites may have more than one on-prem hyperconverged system.

As shown in FIG. 1, the distributed system 100 further includes a cloud service 106 that supports the on-prem hyperconverged systems 102 located at different on-premises sites 104. The cloud service 106 includes a service control manager 108, which manages various operations for the on-prem hyperconverged systems 102. The functions of the service control manager 108 are described below.

The cloud service 106 further includes a number of virtual private clouds (VPCs) 110 (e.g., 110A, 110B . . . ), which are assigned to the on-prem hyperconverged systems 102. In an embodiment, each VPC is assigned to a particular on-prem hyperconverged system. Thus, in this embodiment, the VPC 110A is assigned to the on-prem hyperconverged system 102A, the VPC 110B is assigned to the on-prem hyperconverged system 102B, and so on. As explained below, the VPCs may be used to support the assigned on-prem hyperconverged systems when additional resources are needed.

As shown in FIG. 1, the service control manager 108 and the VPCs in the cloud service 106, and the on-prem hyperconverged systems 102 are connected to a network 112. The network 112 may be a customer provided wide area network (WAN) which allows the cloud service 106 to connect to the different on-prem hyperconverged systems 102.

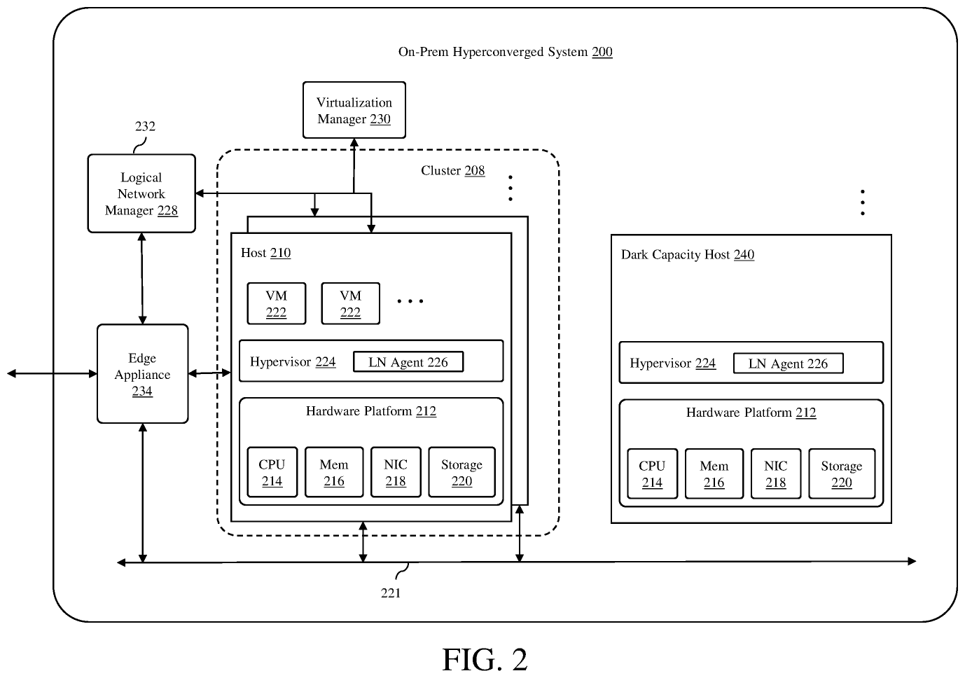

Turning now to FIG. 2, an on-prem hyperconverged system 200, which is representative of the on-prem hyperconverged systems 102, that may be supplied and managed by the cloud service 106 in accordance with an embodiment of the invention is illustrated. As shown in FIG. 2, the on-prem hyperconverged system 200 includes a cluster 208 of host computers (“hosts”) 210, which may be bare metal instances/servers. The hosts may be constructed on a server grade hardware platform 212, such as an x86 architecture platform. As shown, the hardware platform of each host may include conventional components of a computing device, such as one or more processors (e.g., CPUs) 214, system memory 216, a network interface 218, and storage 220. The processor 214 can be any type of a processor commonly used in servers. The memory 216 is volatile memory used for retrieving programs and processing data. The memory 216 may include, for example, one or more random access memory (RAM) modules. The network interface 218 enables the host 210 to communicate with other devices that are inside or outside of the on-prem hyperconverged system 200 via a communication medium, such as a network 221. The network interface 218 may be one or more network adapters, also referred to as a Network Interface Card (NIC). The storage 220 represents one or more local storage devices (e.g., one or more hard disks, flash memory modules, solid state disks and optical disks), which may be used to form a virtual storage area network (SAN).

Each host 210 may be configured to provide a virtualization layer that abstracts processor, memory, storage and networking resources of the hardware platform 212 into the virtual computing instances, e.g., virtual machines 222, that run concurrently on the same host. The virtual machines run on top of a software interface layer, which is referred to herein as a hypervisor 224, that enables sharing of the hardware resources of the host by the virtual machines. One example of the hypervisor 224 that may be used in an embodiment described herein is a VMware ESXi™ hypervisor provided as part of the VMware vSphere® solution made commercially available from VMware, Inc. The hypervisor 224 may run on top of the operating system of the host or directly on hardware components of the host. For other types of virtual computing instances, the host may include other virtualization software platforms to support those virtual computing instances, such as Docker virtualization platform to support “containers”.

In the illustrated embodiment, the hypervisor 224 includes a logical network (LN) agent 226, which operates to provide logical networking capabilities, also referred to as “software-defined networking” (SDN). Each logical network may include software managed and implemented network services, such as bridging, L3 routing, L2 switching, network address translation (NAT), and firewall capabilities, to support one or more logical overlay networks in the on-prem hyperconverged system 200. The logical network agent 226 receives configuration information from a logical network manager 228 (which may include a control plane cluster) and, based on this information, populates forwarding, firewall and/or other action tables for dropping or directing packets between the virtual machines 222 in the host 210, and other virtual computing instances on other hosts, and/or outside of the on-prem hyperconverged system 200. Collectively, the logical network agent 226, together with other agents on other hosts, according to their forwarding/routing tables, implement isolated overlay networks that can connect arbitrarily selected virtual machines or other virtual computing instances with each other. Each virtual machine or virtual computing instance may be arbitrarily assigned a particular logical network in a manner that decouples the overlay network topology from the underlying physical network. Generally, this is achieved by encapsulating packets at a source host and decapsulating packets at a destination host so that virtual machines on the source and destination can communicate without regard to underlying physical network topology. In a particular implementation, the logical network agent 226 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols such as stateless transport tunneling (STT), Network Virtualization using Generic Routing Encapsulation (NVGRE), or Geneve, instead of, or in addition to, VXLAN.

In an embodiment, the hypervisor 224 may further include a high availability (HA) agent and a local scheduler. The HA agents in the hypervisors of the hosts 210 facilitate a high availability feature of the cluster 208. The HA agents monitor the hosts and the virtual computing instances, e.g., virtual machines, running on the hosts to detect software and/or hardware failures. When failures are detected, the HA feature may migrate the affected virtual machines to other hosts in the cluster. In a particular implementation, the HA agents enable the VMware vSphere® High Availability solution.

The local scheduler in the hypervisor in each of the hosts 210 facilitate the resource scheduler feature of the cluster 208. The local schedulers are part of a distributed resource scheduler solution that provides highly available resources to workloads running on the hosts. In addition, the distributed resource scheduler solution balances workloads across the different hosts for optimal performance. The distributed resource scheduler solution also scales and manages computing resources without service disruption. In a particular implementation, the local schedulers enable the VMware vSphere® Distributed Resource Scheduler™ solution.

The cluster 208 of the hosts 210 is a logical grouping of hosts that are configured to share their resources. Consequently, the cluster 208 has as aggregated capacities of various resources, such as CPU, memory and storage. When a new host is added to the cluster, the aggregated resources of the cluster are increased by the resources of the new host. In an embodiment, the cluster may be used to enable various operations, such as high availability and load balancing.

The on-prem hyperconverged system 200 also includes a virtualization manager 230 that communicates with the hosts 210 via a management network 232. In an embodiment, the virtualization manager 230 is a computer program that resides and executes in a computer system, such as one of the hosts, or in a virtual computing instance, such as one of the virtual machines 222 running on the hosts. One example of the virtualization manager 230 is the VMware vCenter Server® product made available from VMware, Inc. The virtualization manager is configured to carry out administrative tasks for a cluster of hosts that forms an SDDC, including managing the hosts in the cluster, managing the virtual machines running within each host in the cluster, provisioning virtual machines, migrating virtual machines from one host to another host, and load balancing between the hosts in the cluster.

As noted above, the on-prem hyperconverged system 200 also includes the logical network manager 228 (which may include a control plane cluster), which operates with the logical network agents 226 in the hosts 210 to manage and control logical overlay networks in the on-prem hyperconverged system. Logical overlay networks comprise logical network devices and connections that are mapped to physical networking resources, e.g., switches and routers, in a manner analogous to the manner in which other physical resources as compute and storage are virtualized. In an embodiment, the logical network manager 228 has access to information regarding physical components and logical overlay network components in the on-prem hyperconverged system. With the physical and logical overlay network information, the logical network manager 228 is able to map logical network configurations to the physical network components that convey, route, and filter physical traffic in the on-prem hyperconverged system 200. In one particular implementation, the logical network manager 228 is a VMware NSX™ manager running on any computer, such as one of the hosts or a virtual machine in the on-prem hyperconverged system 200.

The on-prem hyperconverged system 200 also includes at least one physical edge appliance 234 to control network traffic between the on-prem hyperconverged system 200 and the network 112. The edge appliance allows the cloud service 106 to access various software components of the on-prem hyperconverged system 200 via the network 112. The on-prem hyperconverged system 200 may implemented as a single physical server rack with all the described hardware and software components or in multiple physical server racks that are connected to each other.

In some embodiments, the on-prem hyperconverged system 200 may include a point-of-presence (POP) module that communicates directly with the service control manager 108 in the public cloud. The POP module may include various components, such as a reverse proxy unit, a forward proxy unit and an SDDC bringup agent.

In addition, the on-prem hyperconverged system 200 also includes one or more dark capacity hosts 240, which may be similar or identical to the hosts 210 without any active virtual machines, i.e., virtual machines with workloads. The dark capacity hosts 240 are hosts that are not accessible to the users of the on-prem hyperconverged system 200. The dark capacity hosts are only available for consumption for operator level operations, such as planned/unplanned maintenance of hosts in the on-prem hyperconverged system. The dark capacity hosts are not available for consumption for users of the on-prem hyperconverged system since the dark capacity hosts are not part of the cluster 208 and the users are not able to see or consume their resources. The dark capacity hosts can be added to the subnet that has the other hosts, but is held back for availability purposes. As described in more detail below, the dark capacity hosts 240 are reserved for various other non-user operations, including, but not limited to, failover operations, dynamic scaling operations and SDDC upgrade operations.

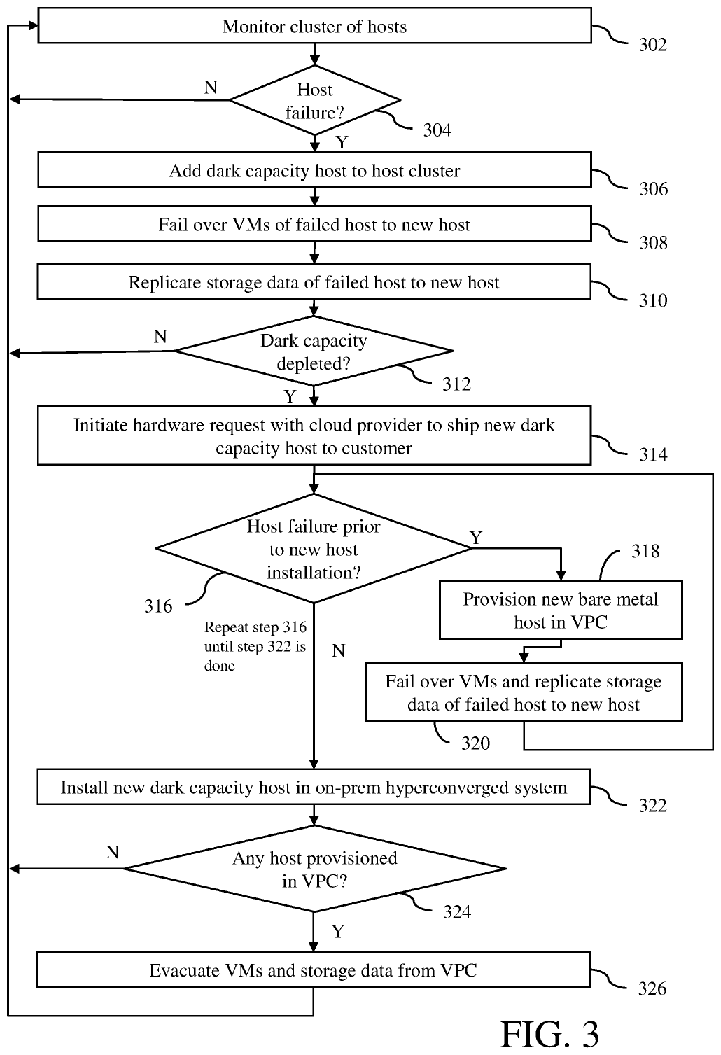

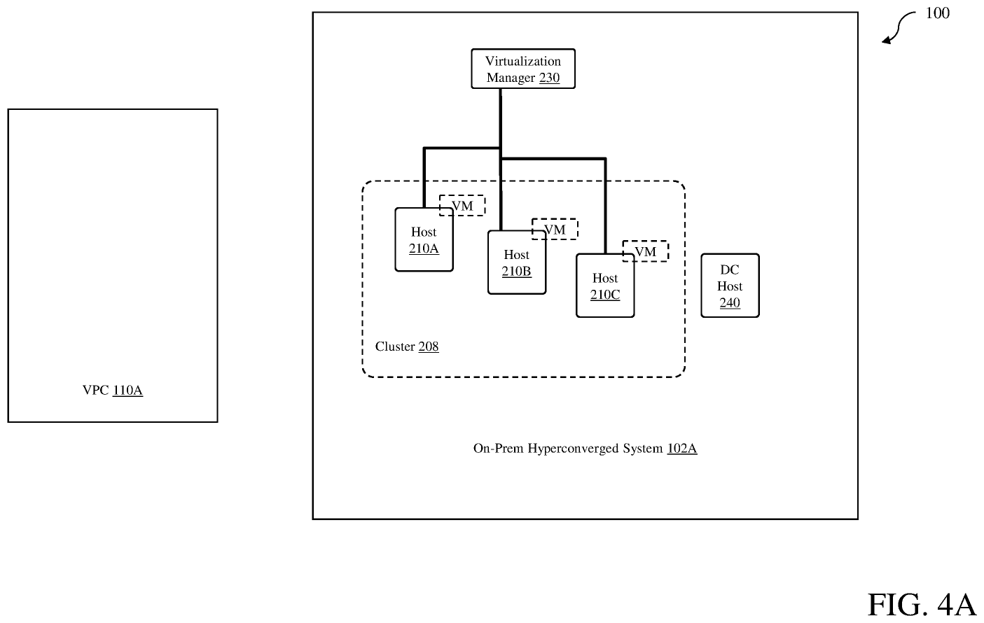

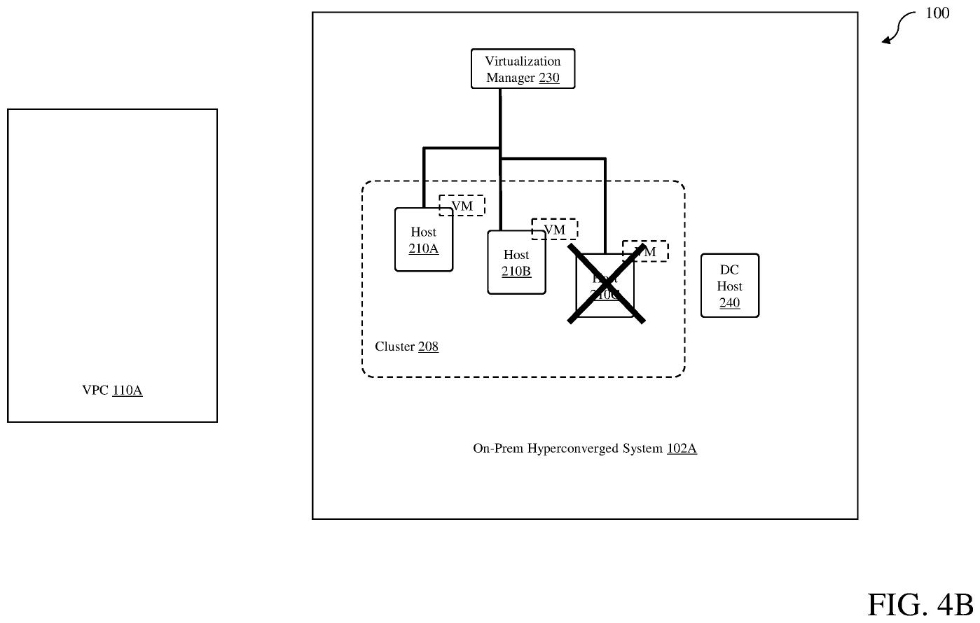

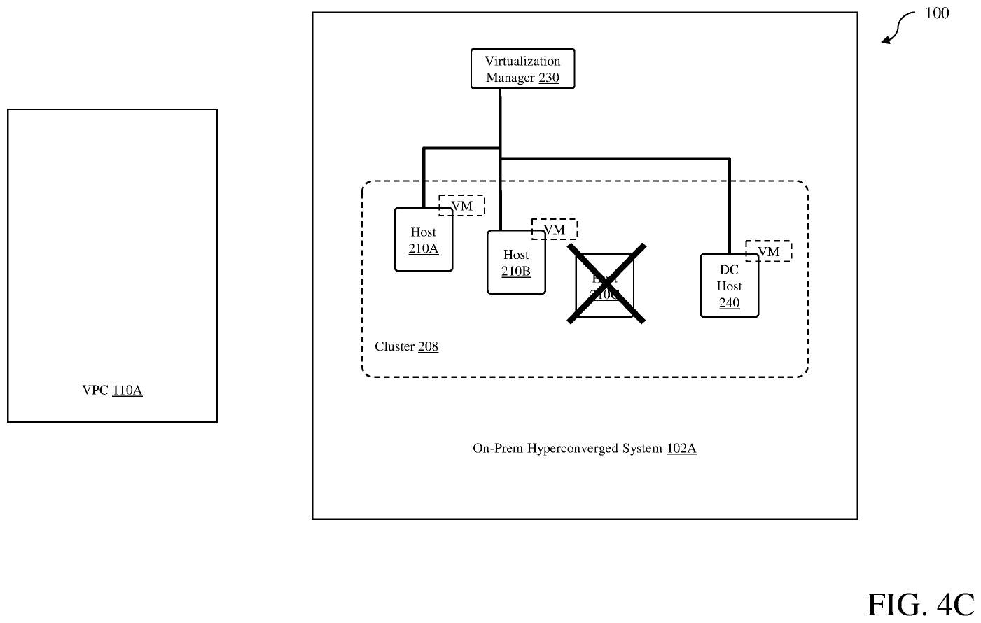

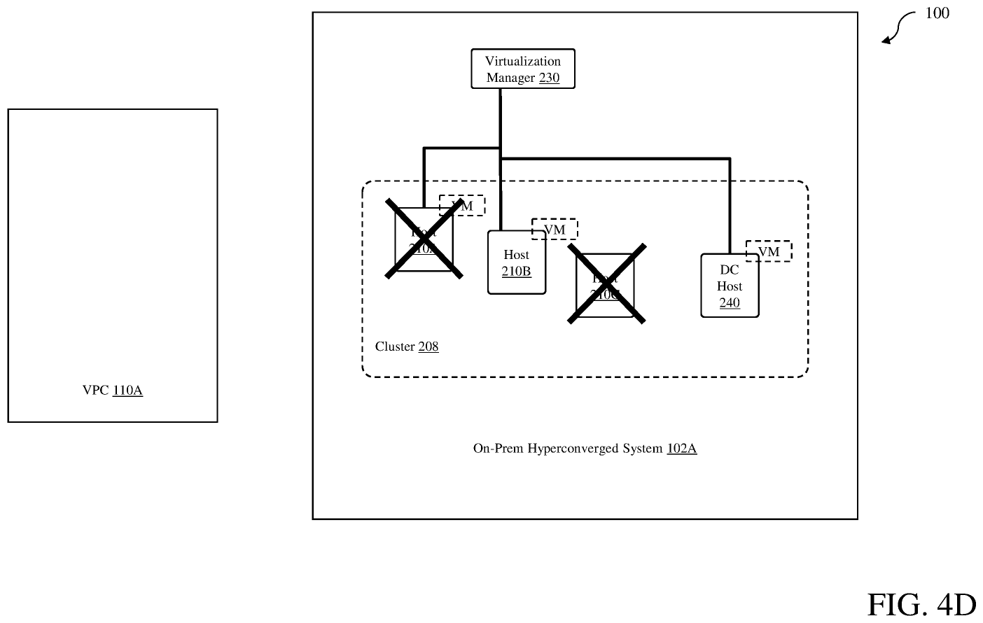

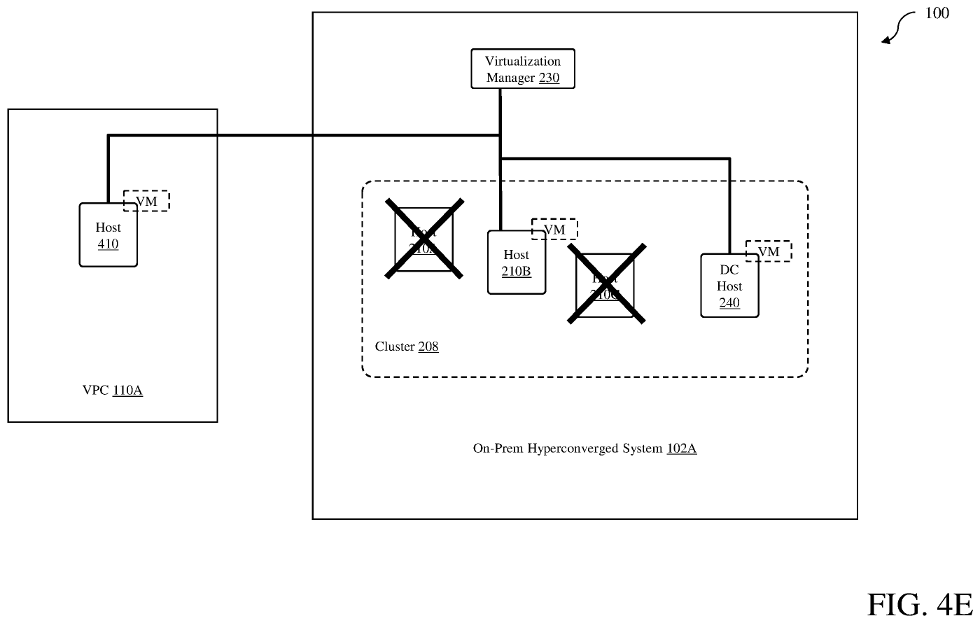

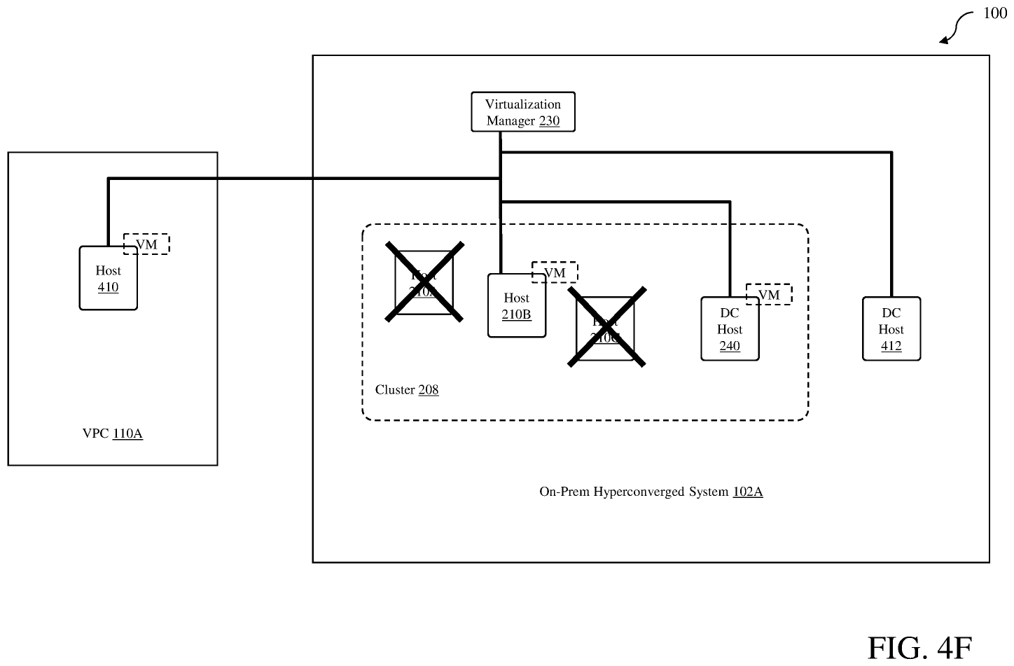

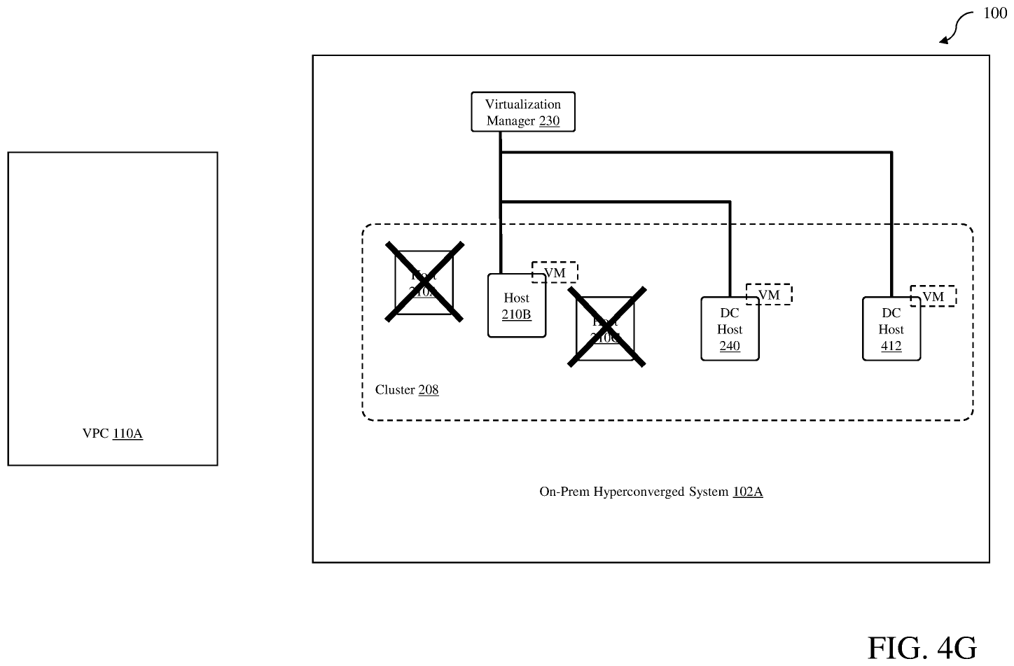

A process of performing a failover operation in an on-prem hyperconverged system of the distributed system 100 in accordance with an embodiment of the invention is described with references to a flow diagram of FIG. 3 using an example of the distributed system 100, which is illustrated in FIGS. 4A-4G. In the example illustrated in FIGS. 4A-4G, the distributed system 100 is shown with only the on-prem hyperconverged system 102A and the VPC 110A, which is assigned to the on-prem hyperconverged system 102A, to describe the failover operation process. As shown in FIG. 4A, the on-prem hyperconverged system 102A includes a virtualization manager 230, and the host cluster 208, which includes three (3) hosts 210A, 210B and 210C. As illustrated in FIG. 4A, each of the hosts 210A, 210B and 210C includes one or more virtual machines (VMs). The on-prem hyperconverged system 102A further includes one dark capacity (DC) host 240.

As shown in FIG. 3, the failover operation process begins at step 302, where the cluster 208 of hosts 210A, 210B and 210C in the on-prem hyperconverged system 102A is monitored by a monitoring entity. In an embodiment, the monitoring entity may be one of the hosts 210A, 210B and 210C in the cluster 208 that has been designated as a primary host of the cluster for high availability. In other embodiments, the monitoring entity may be the virtualization manager 230 or another entity running in the on-prem hyperconverged system 102A.

Next, at step 304, a failure of one of the hosts 210A, 210B and 210C in the cluster 208 is detected by the monitoring entity. The host failure may be detected because, but not limited to, (1) the host has stopped functioning, (2) the host has been network isolated, or (3) the host has lost network connectivity with the monitoring entity. If a host failure is not detected, the monitoring of the cluster 208 of the hosts is continued, back at step 302. However, if a host failure is detected, the process proceeds to step 306. In the illustrated example, the host 210C has failed, as shown in FIG. 4B.

At step 306, the dark capacity host 240 in the on-prem hyperconverged system 102A is added to the host cluster 208 by the virtualization manager 230, as illustrated in FIG. 4C. Thus, the dark capacity host 240 is now similar to any other hosts in the cluster 208. This newly added dark capacity host 240 will now be referred to herein as the new host. Next, at step 308, VMs of the failed host 210C is failed over to the new host 240, as also illustrated in FIG. 4C. In addition, at step 310, the storage data of the failed host, e.g., the virtual SAN data of the failed host 210C, is replicated to the new host 240.

Next, at step 312, a determination is made by the virtualization manager 230 whether the dark capacity of the on-prem hyperconverged system 102A has been depleted due to the dark capacity host 240 being added to the host cluster 208. That is, a determination is made whether there are any dark capacity hosts remaining in the on-prem hyperconverged system 102A. In other embodiments, this determination may be made by the service control manager 108 in the cloud service 106. If the dark capacity of the on-prem hyperconverged system 102A has not been depleted, the process proceeds back to step 302 to continue monitoring the host cluster 208. However, if the dark capacity of the on-prem hyperconverged system 102A has been depleted, i.e., no dark capacity hosts left in the on-prem hyperconverged system 102A, the process proceeds to step 314, where a hardware request is initiated by the service control manager 108 with the cloud provider to ship one or more new dark capacity hosts to the on-premises site 104A so that the new dark capacity host(s) can be manually installed in the on-prem hyperconverged system 102A.

At step 316, a failure of one of the active hosts 210A, 210B and 240 in the cluster 208 is detected by the monitoring entity after the hardware request was initiated but prior to installation of the new dark capacity host(s) in the on-prem hyperconverged system 102A. As noted above, the host failure may be detected because, but not limited to, (1) the host has stopped functioning, (2) the host has been network isolated, or (3) the host has lost network connectivity with the monitoring entity. If a host failure is not detected, the monitoring of the cluster of the hosts is continued until the new dark capacity host(s) are installed. However, if a host failure is detected, the process proceeds to step 318. In the illustrated example, the host 210A has failed, as shown in FIG. 4D.

At step 318, a new bare metal host 410 is provisioned in the virtual private cloud 110A associated with the on-prem hyperconverged system 102A, as illustrated in FIG. 4E. In an embodiment, the bare metal host 410 may be provisioned by the cloud provide in response to a request made by the service control manager 108. Next, at step 320, the VMs of the failed host 210A are failed over to the new bare metal host 410, as also illustrated in FIG. 4E, and the storage data of the failed host 210A is replicated to the new bare metal host 410. The process then continues to step 322. However, if another failure of one of the active hosts 210B and 240 in the cluster 208 is detected by the monitoring entity prior to installation of the new dark capacity host(s) in the on-prem hyperconverged system 102A, steps 318 and 320 are performed again.

In an embodiment, the virtual private cloud 110A is provisioned in the public cloud with a first subnet dedicated for hosts that is explicitly linked to the on-prem hyperconverged system 102A. In addition, a second subnet is provisioned that is associated with the same virtual private cloud 110A. This second subset is provisioned purely in the public cloud. The second subnet is associated with the subnet in the on-prem hyperconverged system 102A so that underlay traffic can easily flow between all the hosts in the on-prem hyperconverged system 102A and the public cloud. Since the on-prem hyperconverged system 102A and the cloud infrastructure share the same underlying network, i.e., the virtual private cloud 110A in this embodiment, there is a route for all the hosts to communicate with each other and the virtualization manager 230.

At step 322, the requested new dark capacity host(s) is/are manually installed in the on-prem hyperconverged system 102A by any capable personnel. In some use cases, the personnel may include a service person sent by the cloud provider. In other use cases, the personnel may include a service person that is hired or directed by the user of the on-prem hyperconverged system 102A. In the illustrated example, a new dark capacity host 412 is installed in the on-prem hyperconverged system 102, as shown in FIG. 4F.

Next, at step 324, a determination is made whether any host has been provisioned in the virtual private cloud 110A. In an embodiment, this determination is made by the virtualization manager 230 and/or the service control manager 108. If no, then the process proceeds back to step 302 to continue monitoring the host cluster 208. If yes, then the process proceeds to step 326, where VMs and storage data are evacuated from the virtual private cloud 110A to the new dark capacity host(s), which are added to the host cluster 208. In the illustrated example, the VMs and storage data are evacuated or migrated from the virtual private cloud 110A to the new dark capacity host 412, which has been added to the host cluster 208, as shown in FIG. 4G. The process then proceeds back to step 302 to continue monitoring the current host cluster 208 in the on-prem hyperconverged system 102A.

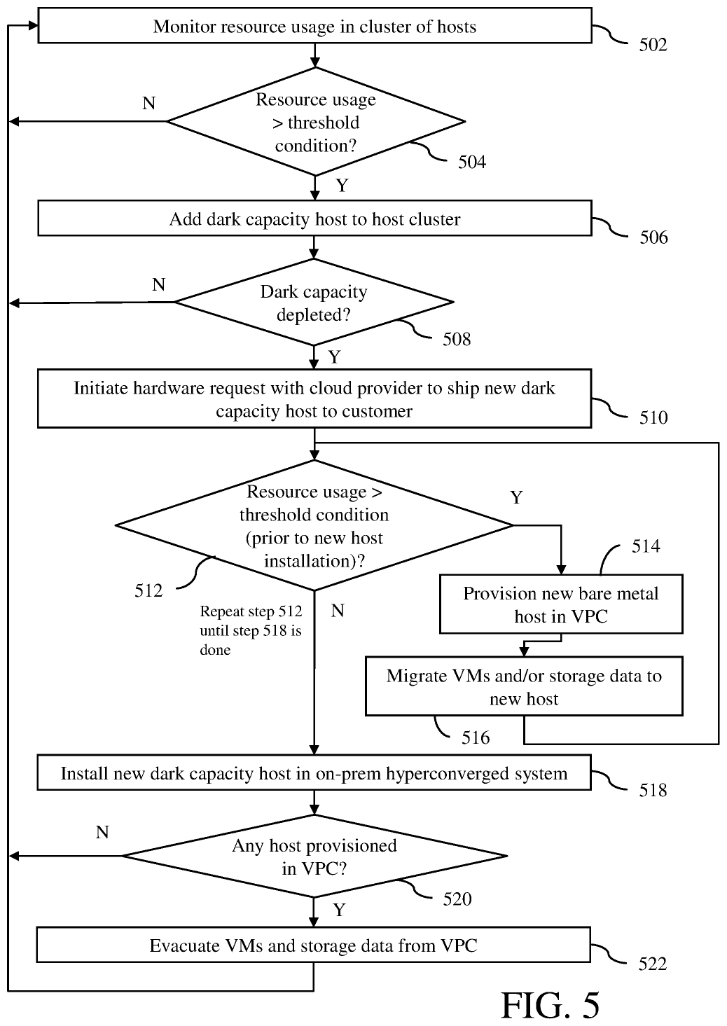

A process of scaling out the resource capacity of an on-prem hyperconverged system of the distributed system 100 in accordance with an embodiment of the invention is described with references to a flow diagram of FIG. 5. The resource capacity being scaled out may be the capacity of CPU, memory and/or storage. In this description of a scaling out process, the on-prem hyperconverged system 102A of the distributed system 100 is used as an example.

As shown in FIG. 5, the scaling out process begins at step 502, where the resource usage in the host cluster 208 of hosts in the on-prem hyperconverged system 102A is monitored by a monitoring entity. The resource usage include CPU usage, memory usage and/or storage usage. In an embodiment, the monitoring entity may be the virtualization manager 230.

Next, at step 504, a determination is made by the monitoring entity whether the current resource usage of the host cluster 208 in the on-prem hyperconverged system 102A is greater than a resource threshold condition. The resource threshold condition depends on the resource usage being monitored. Thus, the resource threshold condition may include a CPU usage threshold, a memory usage threshold and/or a storage usage threshold. In an embodiment, each resource threshold may be a percentage value with respect to the total capacity of the host cluster 208 for a particular type of resources. If the current resource usage of the host cluster 208 is not greater than the resource threshold condition, the process proceeds back to step 502, where monitoring of the resource usage in the host cluster 208 is continued. However, if the current resource usage of the host cluster is greater than the resource threshold condition, the process proceeds to step 506.

At step 506, a dark capacity host in the on-prem hyperconverged system 102A, if available, is added to the host cluster 208 by the virtualization manager 230 to increase the resource capacity of the host cluster. In some embodiments, the process proceeds back to step 502 to continue monitoring the resource usage in the host cluster 208. However, in other embodiments, the process continues to step 508.

At step 508, a determination is made by virtualization manager 230 whether the dark capacity of the on-prem hyperconverged system 102A has been depleted due to the dark capacity host being added to the host cluster 208. In other embodiments, this determination may be made by the service control manager 108 in the cloud service 106. If the dark capacity of the on-prem hyperconverged system 102A has not been depleted, the process proceeds back to step 502 to continue monitoring the resource usage in the host cluster 208. However, if the dark capacity of the on-prem hyperconverged system 102A has been depleted, i.e., no dark capacity hosts left in the on-prem hyperconverged system 102A, the process proceeds to step 510, where a hardware request is initiated by the virtualization manager 230 and/or the service control manager 108 with the cloud provider to ship one or more new dark capacity hosts to the on-premises site 104A so that the new dark capacity host(s) can be manually installed in the on-prem hyperconverged system 102A.

At step 512, a determination is made by the monitoring entity whether the current resource usage in the host cluster 208 of the on-prem hyperconverged system 102A is greater than the resource threshold condition after the hardware request was initiated but prior to installation of the new dark capacity host(s) in the on-prem hyperconverged system 102A. If the current resource usage in the host cluster 208 is not greater than the resource threshold condition, the process performs step 512 again until the new dark capacity host(s) has/have been installed in the on-prem hyperconverged system 102A. However, if the current resource usage of the host cluster is greater than the resource threshold condition, the process proceeds to step 514, where a new bare metal host is provisioned in the virtual private cloud 110A associated with the on-prem hyperconverged system 102A to increase the resource capacity of the host cluster 208. Next, at optional step 516, VMs and/or storage data are migrated from the on-prem hyperconverged system 102A to the new bare metal host in the virtual private cloud 110A. The process then proceeds back to step 512.

At step 518, the new dark capacity host(s) is/are manually installed in the on-prem hyperconverged system 102A by any capable personnel. In some use cases, the personnel may be a service person sent by the cloud provider. Next, at step 520, a determination is made whether any host has been provisioned in the virtual private cloud 110A. In an embodiment, this determination is made by the virtualization manager 230 and/or the service control manager 108. If no, then the process proceeds back to step 502 to continue monitoring the resource usage in the host cluster 208. If yes, then the process proceeds to step 522, where VMs and storage data are migrated from the virtual private cloud 110A to the new dark capacity host(s), which has/have been added to the host cluster 208. The process then proceeds back to step 502 to continue monitoring the resource usage in the current host cluster 208 in the on-prem hyperconverged system 102A.

In some embodiments, the on-prem hyperconverged systems 102 in the distributed system 100 may also support scale-in operations to remove one or more hosts from their clusters 208 when resource usages in the clusters fall below certain resource thresholds.

In an embodiment, the dark capacity in the on-prem hyperconverged system 102 may also be used for upgrade operations when additional resources may be needed. As an example, during an upgrade of an SDDC on an on-prem hyperconverged system, additional host may be needed to meet the customer's service level agreement (SLA). In this situation, the dark capacity in the on-prem hyperconverged system where the upgrade operation is needed can be used to meet the SLA requirements until the upgrade operation is completed. Thus, a dark capacity host in the on-prem hyperconverged system may be added to the host cluster for the upgrade operation, and then removed from the host cluster once the upgrade operation is completed to be put back as dark capacity.

Thus, the dark capacity hosts 240 in the on-prem hyperconverged systems 102 are used when a condition for additional resources, such as a host failure, a scale-out condition and an initiation of an upgrade operation, is detected. When such a condition for additional resources is detected, one or more dark capacity hosts 240 are added to the host cluster 208 to increase the aggregated resource capacity of the host cluster. Then, the resources of the added dark capacity hosts 240 are used to address or resolve the detected condition for additional resources.

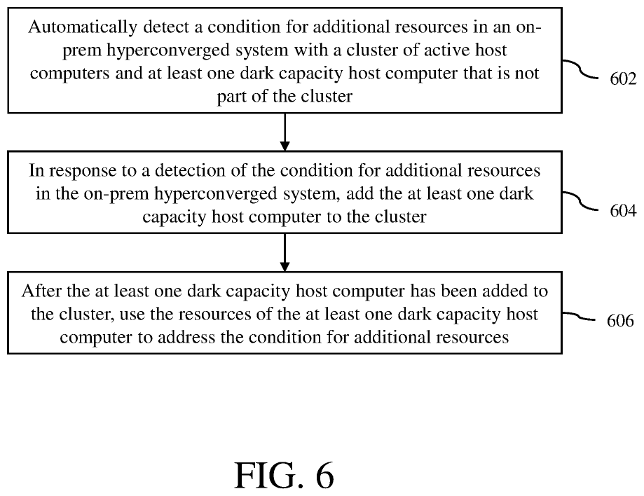

A computer-implemented method for managing on-prem hyperconverged systems in accordance with an embodiment of the invention is described with reference to a process flow diagram of FIG. 6. At block 602, a condition for additional resources in an on-prem hyperconverged system with a cluster of active host computers and at least one dark capacity host computer that is not part of the cluster is detected. The active and dark capacity host computers are physical computers. At block 604, in response to a detection of the condition for additional resources in the on-prem hyperconverged system, the at least one dark capacity host computer is added to the cluster. At block 606, after the at least one dark capacity host computer has been added to the cluster, the resources of the at least one dark capacity host computer are used to address the condition for additional resources.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for managing on-prem hyperconverged systems, the method comprising:
automatically detecting a condition for additional resources in an on-prem hyperconverged system with a cluster of active host computers and at least one dark capacity host computer that is not part of the cluster, wherein the active and dark capacity host computers are physical computers;
in response to a detection of the condition for additional resources in the on-prem hyperconverged system, adding the at least one dark capacity host computer to the cluster; and
after the at least one dark capacity host computer has been added to the cluster, using resources of the at least one dark capacity host computer to address the condition for additional resources.

2. The computer-implemented method of claim 1, wherein the condition for additional resources is a failure of a particular host computer among the active host computers in the cluster, and wherein using the resources of the at least one dark capacity host computer includes failing over any virtual computing instance on the particular host computer to the at least one dark capacity host computer that has been added to the cluster.

3. The computer-implemented method of claim 2, wherein using the resources of the at least one dark capacity host computer further includes replicating storage data of the particular host computer to the at least one dark capacity host computer, wherein the storage data of the particular host computer is part of a virtual storage array network.

4. The computer-implemented method of claim 2, further comprising initiating a request for a new dark capacity host computer to be installed in the on-prem hyperconverged system.

5. The computer-implemented method of claim 4, further comprising:
automatically detecting another failure of another host computer of the active host computers in the cluster after the initiating of the request and before the new dark capacity host computer is installed in the on-prem hyperconverged system;
provisioning a host computer in a virtual private cloud within a public cloud; and
failing over any virtual computing instance of the another host computer to the host computer in the virtual private cloud.

6. The computer-implemented method of claim 1, further comprising evacuating any virtual computing instance in a virtual private cloud assigned to the on-prem hyperconverged system to a new dark capacity host computer after the new dark capacity host computer has been added to the cluster.

7. The computer-implemented method of claim 1, wherein the condition for additional resources is a scale-out condition in the cluster, and wherein using the resources of the at least one dark capacity host computer includes using the resources of the at least one dark capacity host computer to increase aggregated resources available in the cluster.

8. The computer-implemented method of claim 1, wherein the condition for additional resources is an initiation of an upgrade operation in the on-prem hyperconverged system, and wherein using the resources of the at least one dark capacity host computer includes using the resources of the at least one dark capacity host computer for the upgrade operation to meet service-level agreement (SLA) requirements.

9. A non-transitory computer-readable storage medium containing program instructions for managing on-prem hyperconverged systems, wherein execution of the program instructions by one or more processors causes the one or more processors to perform steps comprising:
automatically detecting a condition for additional resources in an on-prem hyperconverged system with a cluster of active host computers and at least one dark capacity host computer that is not part of the cluster, wherein the active and dark capacity host computers are physical computers;
in response to a detection of the condition for additional resources in the on-prem hyperconverged system, adding the at least one dark capacity host computer to the cluster; and
after the at least one dark capacity host computer has been added to the cluster, using resources of the at least one dark capacity host computer to address the condition for additional resources.

10. The non-transitory computer-readable storage medium of claim 9, wherein the condition for additional resources is a failure of a particular host computer among the active host computers in the cluster, and wherein using the resources of the at least one dark capacity host computer includes failing over any virtual computing instance on the particular host computer to the at least one dark capacity host computer that has been added to the cluster.

11. The non-transitory computer-readable storage medium of claim 10, wherein using the resources of the at least one dark capacity host computer further includes replicating storage data of the particular host computer to the at least one dark capacity host computer, wherein the storage data of the particular host computer is part of a virtual storage array network.

12. The non-transitory computer-readable storage medium of claim 10, wherein the steps further comprise initiating a request for a new dark capacity host computer to be installed in the on-prem hyperconverged system.

13. The non-transitory computer-readable storage medium of claim 12, wherein the steps further comprise:
automatically detecting another failure of another host computer of the active host computers in the cluster after the initiating of the request and before the new dark capacity host computer is installed in the on-prem hyperconverged system;
provisioning a host computer in a virtual private cloud within a public cloud; and
failing over any virtual computing instance of the another host computer to the host computer in the virtual private cloud.

14. The non-transitory computer-readable storage medium of claim 9, wherein the steps further comprise evacuating any virtual computing instance in a virtual private cloud assigned to the on-prem hyperconverged system to a new dark capacity host computer after the new dark capacity host computer has been added to the cluster.

15. The non-transitory computer-readable storage medium of claim 9, wherein the condition for additional resources is a scale-out condition in the cluster, and wherein using the resources of the at least one dark capacity host computer includes using the resources of the at least one dark capacity host computer to increase aggregated resources available in the cluster.

16. The non-transitory computer-readable storage medium of claim 9, wherein the condition for additional resources is an initiation of an upgrade operation in the on-prem hyperconverged system, and wherein using the resources of the at least one dark capacity host computer includes using the resources of the at least one dark capacity host computer for the upgrade operation to meet service-level agreement (SLA) requirements.

17. A system comprising:
memory; and
at least one processor configured to:
automatically detect a condition for additional resources in an on-prem hyperconverged system with a cluster of active host computers and at least one dark capacity host computer that is not part of the cluster, wherein the active and dark capacity host computers are physical computers;
in response to a detection of the condition for additional resources in the on-prem hyperconverged system, add the at least one dark capacity host computer to the cluster; and
after the at least one dark capacity host computer has been added to the cluster, use resources of the at least one dark capacity host computer to address the condition for additional resources.

18. The system of claim 17, wherein the condition for additional resources is a failure of a particular host computer among the active host computers in the cluster, and wherein the at least one processor is configured to fail any virtual computing instance on the particular host computer to the at least one dark capacity host computer that has been added to the cluster.

19. The system of claim 17, wherein the condition for additional resources is a scale-out condition in the cluster, and wherein the at least one processor is configured to use the resources of the at least one dark capacity host computer to increase aggregated resources available in the cluster.

20. The system of claim 17, wherein the condition for additional resources is an initiation of an upgrade operation in the on-prem hyperconverged system, and wherein the at least one processor is configured to use the resources of the at least one dark capacity host computer for the upgrade operation to meet service-level agreement (SLA) requirements.
